(19) United States
(12) Patent Application Publication
(10) Pub. No.: US 2003/0179231 A1
(43) Pub. Date: Sep. 25, 2003

(54) Method for browsing virtual three-dimensional information, computer program and storage medium

(75) Inventors: Toru Kamiwada, Kawasaki (JP); Takushi Fujita, Kawasaki (JP); Takuya Sakamoto, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/270,194

(22) Filed: Oct. 15, 2002

(30) Foreign Application Priority Data
Mar. 20, 2002 (JP) 2002-079279

(51) Int. Cl. G09G 5/00

(52) U.S. Cl. 345/757; 345/850

(57) ABSTRACT

A method for browsing virtual three-dimensional information is provided in which a display is changed automatically while maintaining link relationship among information objects displayed in a virtual three-dimensional space. Plural information objects related to each other by a link structure are located in the virtual three-dimensional space, and some of them are displayed on the display screen of a computer. The display including the information objects are changed in accordance with a field from a viewpoint that moves responding to user's operation. A destination list is displayed on the display screen. The destination list includes a plurality of icons or character strings related respectively to the information objects located on the virtual three-dimensional space. When an icon or a character string included in the destination list is selected as a destination by an input device, a control portion searches a destination information object that is related to the selected icon or character string in accordance with the link structure and changes the display screen so as to alter tracing a link to the state of view where the destination information object is displayed.

### BACKGROUND OF THE INVENTION

1. Field of the Invention

The present invention relates to a method for browsing virtual three-dimensional information by locating a plurality of information objects that are related to each other by a link structure in a virtual three-dimensional space, displaying some of the information objects on a display screen of a computer and changing the display including the information objects in accordance with a field from a viewpoint that alters responding to user's operation.

2. Description of the Prior Art

A computer having a large capacity storage device such as a hard disk drive or a digital versatile disk drive as well as a computer connected to a network such as the Internet can obtain and utilize an enormous amount of information and various types of information. Such information can be utilized usually by displaying the obtained information on a display screen of a computer.

In order to use a limited size of display screen efficiently and to display information with good viewability for users, a graphical user interface (GUI) utilizing a multi-window system such as Microsoft Windows (a registered trade mark) is used widely. In the GUI utilizing the multi-window system, plural pieces of information are displayed in plural display windows, which are overlaid on a two-dimensional display screen, so that many pieces of information can be displayed on one display screen.

In the GUI utilizing the multi-window system, links to other information can be embedded in information displayed in a window. For example, a hypertext markup language (HTML) is used for describing the links. When the user selects a link using a pointing device such as a mouse, information of the link destination is displayed. Programs (such as Microsoft Internet Explorer) are widely used for browsing such plural pieces of information related to each other by a link structure one after another by a simple operation.

In general, when a link is selected by the pointing device, display contents in the display window about information of the link origin are changed instantly so as to display information of the link destination. Alternatively, another window is created for displaying information of the link destination, and the created window becomes an active window displayed on the front of the window displaying the original information.

The operation of tracing the link so as to change display information one after another has usually no means for directly displaying a history of the selected links. Therefore, it is difficult to grasp the relationship between information of the link origin and information of the link destination in the method where contents of display changes one after another in one window.

In contrast, concerning the method where information of the link destination is displayed in a new window every time when a link destination is selected, windows of information on the path from the link origin to the link destination are remained on the display screen. Therefore, the user can see information on the path by switching an active window, so as to understand easily the relationship between the information of the link origin and the information of the link destination. However, if the number of links on the path increases, the number of windows remaining on the display screen increases so that many windows may overlap, resulting in difficulty in grabbing the relationship among the windows.

In order to solve the complicated display screen of many pieces of information (or windows), an information browsing method can be utilized in which information is displayed in a virtual three-dimensional space on a display screen of a computer (see Japanese unexamined patent publication No. 9-73553, for example). In this information browsing method, various types of information are located as information objects in a virtual three-dimensional space, and the information from a viewpoint that is set within the virtual three-dimensional space is changed responding to user's operation so that the display of the information objects is changed.

The display in the virtual three-dimensional space enables more abundant display methods such that relationship among plural pieces of information can be shown by positions and sizes of the information objects. For example, when displaying information of the link origin, a small information object of the link destination is placed at the position where the link exists. In this case, by operating to trace the link so that a viewpoint approaches the position of the information object of the link destination, a user can observe the trace of the link like an animation. If the links are traced one after another by this method, since the link information remains as relative positions in the virtual three-dimensional space, the relationship of the links can be grabbed more easily than the case where windows are switched one after another.

However, there is a problem as follows in the information browsing method utilizing the virtual three-dimensional space as explained above. It is supposed that while browsing certain information it becomes necessary to display another information object having relatively little relevance to the information that is currently displayed. This operation can be easily performed in the above-mentioned two methods utilizing the normal two-dimensional display window (or windows). Namely, when the display of another information object is instructed, the contents of the display window are switched to that of the designated information, or a new window is displayed for the designated information.

However, since the information browsing method utilizing the virtual three-dimensional space is based on tracing the link relationship by moving a viewpoint, it is difficult to switch the display abruptly like the normal two-dimensional display window. If the display contents of the window are switched abruptly to the display of the designated information, the advantage of the information browsing method utilizing the virtual three-dimensional space, i.e., easiness in grabbing link relationship by positions may be lost.

Otherwise, if a new information object appears in the virtual three-dimensional space abruptly instead of displaying a new window, new relationship is required to be generated regardless of the relationship with other information objects, which may cause confusion in grabbing the link relationship with high probability. Especially, if such a display change is repeated, information objects having little relevance may gather in the virtual three-dimensional space, which causes more difficulty in grabbing the relationship among plural pieces of information.

### SUMMARY OF THE INVENTION

An object of the present invention is to provide a method for browsing virtual three-dimensional information, in which even if display of information having little relevance to the current information is instructed, the display can be changed sequentially without deteriorating easiness in grabbing link relationship among information objects shown in the virtual three-dimensional space.

A virtual three-dimensional information browsing method according to the present invention comprises the steps of locating a plurality of information objects that are related to each other by a link structure in a virtual three-dimensional space, displaying some of the information objects on a display screen of a computer, changing the display including the information objects in accordance with a field from a viewpoint that moves responding to user's operation, and displaying a destination list on the display screen, the destination list including a plurality of icons or character strings related respectively to the information objects located on the virtual three-dimensional space. When an icon or a character string included in the destination list is selected as a destination by an input device, a control portion searches a destination information object that is related to the selected icon or character string in accordance with the link structure and changes the display screen so as to alter tracing a link to the state of view where the destination information object is displayed.

According to this method, the viewpoint can be moved automatically to an information object having little relevance while maintaining relative positions (i.e., link relationship) among the information objects located in the virtual three-dimensional space. Therefore, the user can browse various kinds of information easily with grabbing information relationship. Since the relationship among the information objects can be visualized in the virtual three-dimensional space that is displayed by the automatic movement of the viewpoint, a complicated information structure can be grabbed without difficulty.

In a preferred embodiment, each of the plural icons or character strings is related to an identifier indicating the destination information object and the identifiers of the plural information objects on the path to the destination information object in accordance with the link structure. As the identifier of the information object, a URL (Uniform Resource Locator) is used usually. The path tracing a link from an information object to a destination information object is not always a single path but there are usually plural paths. In this case, it is preferable to specify the path to be traced to the destination information by designating plural URLs.

In addition, it is preferable to display the character string or the icon as an anchor in relationship with a URL of the destination of this automatic movement and URLs that form the path to the destination, and to start the automatic movement responding to user's operation for selecting the anchor. Thus, complicated automatic movement can be realized by a simple operation.

In the above-mentioned search process, it is preferable that if the link information of the information object on the path is not read yet, the link information is read newly before continuing the destination search. Thus, a type of preread of the path information enables smooth search of the destination information object.

A computer program according to the present invention for realizing the above-mentioned virtual three-dimensional information browsing method makes a computer perform the process that comprises the steps of locating a plurality of information objects that are related to each other by a link structure in a virtual three-dimensional space, displaying some of the information objects on a display screen of a computer, changing the display including the information objects in accordance with a field from a viewpoint that alters responding to user's operation, displaying a destination list on the display screen, the destination list including a plurality of icons or character strings related respectively to the information objects located on the virtual three-dimensional space, searching a destination information object that is related to the selected icon or character string in accordance with the link structure when an icon or a character string included in the destination list is selected as a destination by an input device, and changing the display screen to alter with tracing a link to the state of view where the destination information object is displayed.

Such a computer program can be stored in a computer readable storage medium such as a CD-ROM for supply and installed from the storage medium into a computer to be executed.

### BRIEF DESCRIPTION OF THE DRAWINGS

FIG. 1 is a block diagram showing an example of a computer system for realizing a method for browsing virtual three-dimensional information according to the present invention.

FIG. 2 shows an example of information objects in the virtual three-dimensional space displayed on a display screen of a display device.

FIG. 3 shows a link relationship among the information objects shown in FIG. 2.

FIG. 4 shows an example of change in display when the viewpoint approaches from the display screen shown in FIG. 2 to the sphere information object.

FIG. 5 shows an example of change in display when the viewpoint further approaches from the display screen shown in (c) of FIG. 4 to one information object on the sphere information object.

FIG. 6 is a flowchart of a first example showing a general process of the URL search.

FIG. 7 is a flowchart of a second example showing a general process of the URL search.

FIG. 8 shows a first example of a display form of the destination list.

FIG. 9 shows a second example of the display form of the destination list.

FIG. 10 shows a third example of the display form of the destination list.

FIG. 11 shows an example in which the destination list is displayed in a hierarchy manner indicating the link structure among the information objects.

### DESCRIPTION OF THE PREFERRED EMBODIMENTS

Hereinafter, the present invention will be explained more in detail with reference to embodiments and drawings.

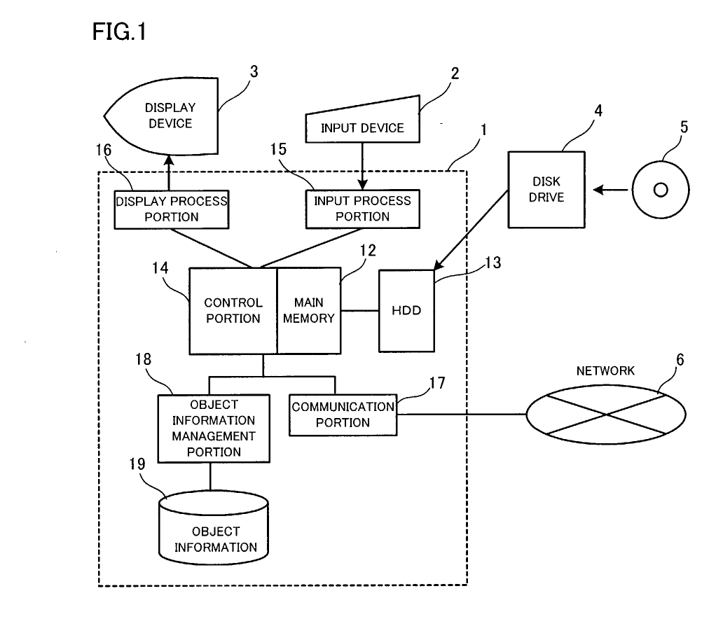

FIG. 1 is a block diagram showing an example of a computer system for realizing a method for browsing virtual three-dimensional information according to the present invention. The virtual three-dimensional information browsing method of the present invention can be embodied by installing a special-purpose program (that can be a part of a system program) into a computer system such as a personal computer or a workstation. This program for browsing virtual three-dimensional information can be supplied with being stored in a storage medium 5 such as a CD-ROM (i.e., an optical disk) and is installed in an auxiliary storage device (such as a hard disk drive) 13 of a computer 1 using a disk drive 4.

The program installed in the auxiliary storage device 13 is loaded into a main memory 12 and executed by a control portion (CPU) 14. The computer 1 includes the main memory 12, the auxiliary storage device 13, the control portion 14, an input process portion 15 and a display process portion 16. The input process portion 15 is connected to an input device 2 such as a keyboard and a mouse, while the display process portion 16 is connected to a display device 3 such as a cathode ray tube (a CRT) or a liquid crystal display (an LCD).

Furthermore, a communication portion 17 for making connection with a network 6 such as the Internet and an object information management portion 18 for managing object information 19 is connected to the control portion 14. Objects that were read from the outside via the communication portion 17 are transferred to the object information management portion 18, which processes them to be the object information 19 to be managed. The object information management portion 18 can be constituted as a part of the control portion 14. In addition, the object information 19 can be-included in data that are stored in the auxiliary storage device 13. In the system of this embodiment, an example will be explained in which information on the network 6 is browsed.

In FIG. 1, information from the input device 2 is transferred to the control portion 14 via the input process portion 15. The control portion 14 manages information of the virtual three-dimensional space such as a current viewpoint location and performs processes such as moving the viewpoint responding to information from the input process portion 15. In addition, the control portion 14 obtains the object information 19 via the object information management portion 18 and generates display data such as positions and sizes of information objects to be displayed from information of field from the current viewpoint. The display data are transferred to the display process portion 16.

The display process portion 16 displays information in the display device 3 in accordance with the display data from the control portion 14. In this program, various forms of the information object such as text data, an image or a three-dimensional shape object can be displayed, and each information object can have link information to other information objects. The user uses the input device 2 to conduct operation of moving the viewpoint in the virtual three-dimensional space so as to browse various information objects that are connected by the link.

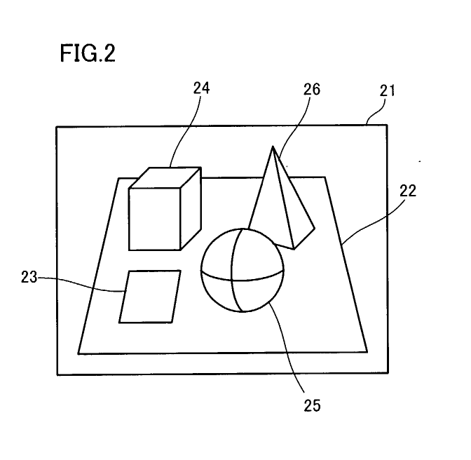

FIG. 2 shows an example of information objects in the virtual three-dimensional space displayed on a display screen 21 of the display device 3. In this example, a large plate 22 is one information object, which has links to four information objects, i.e., a small plate 23, a box 24, a sphere 25 and a pyramid 26.

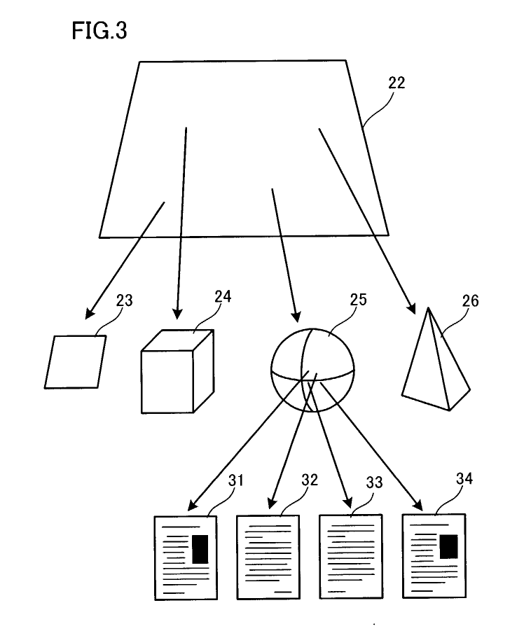

FIG. 3 shows a link relationship among the information objects shown in FIG. 2. In FIG. 3, arrow lines indicate link relationship among the information objects. It is understood from FIG. 3 that the information object of the sphere 25 has links to four information objects (documents) 31-34, and that these information objects 31-34 are placed on the surface of the sphere information object 25, though they don't appear in the display shown in FIG. 2.

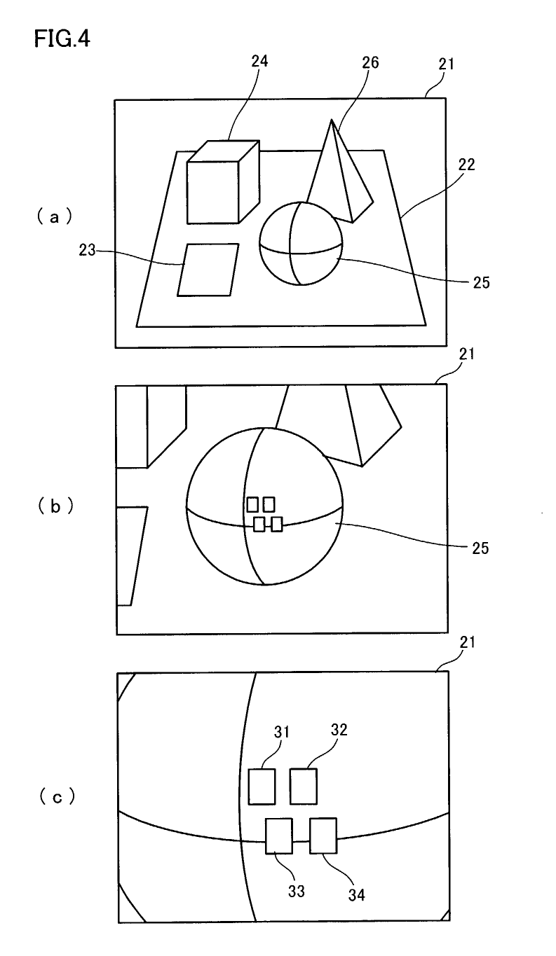

FIG. 4 shows an example of change in display when the viewpoint approaches from the display screen 21 shown in FIG. 2 to the sphere information object 25. When the user conducts operation of the input device 2 such as a mouse on the display screen 21 shown in FIG. 2 so as to approach the sphere information object 25, the display screen alters as shown in (a) through (c) of FIG. 4. Namely, the sphere information object 25 is enlarged (zoomed in), and the four information objects 31-34 located on the surface of the sphere become visible gradually. This program is mainly applied to such a method for browsing virtual three-dimensional information in which various types of information can be browsed by operation of moving the viewpoint. A process for reading information to be displayed from the network is controlled in accordance with the relationship to the viewpoint location.

In the viewpoint location of (a) shown in FIG. 4, information about the large plate information object 22 is read from the network 6 via the communication portion 17 first and transferred to the object information management portion 18. The object information management portion 18 analyzes the received information and obtains data to be displayed in the virtual three-dimensional space or the link information to other information objects, which are managed as object information. After analyzing the link information, the link destination information of the information objects 23-26, which were found to be at locations to be displayed on the display screen 21 in relationship with the viewpoint location, are obtained in the same way and are stored as the object information 19.

When approaching the sphere information object 25 until the display shown in (b) of FIG. 4, the four information objects 31-34 that are included in the link information of the sphere information object 25 come to the positions to be displayed. Therefore, these information objects are obtained and displayed, too. In the display shown in (c) of FIG. 4, the four information objects 31-34 are further enlarged (zoomed in), so that contents of their text are displayed.

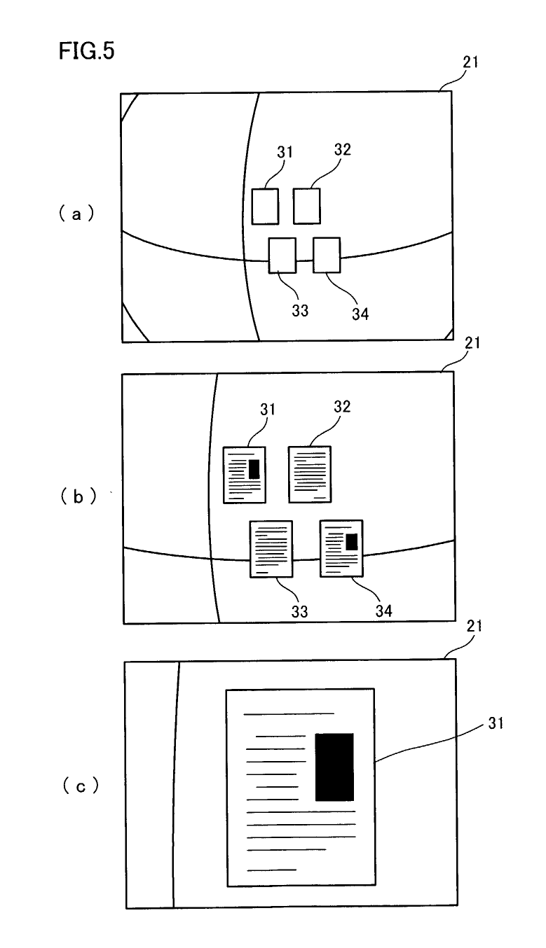

FIG. 5 shows an example of change in display when the viewpoint further approaches from the display screen 21 shown in (c) of FIG. 4 to one information object on the sphere information object 25. In this example, the viewpoint approaches the information object 31 on the sphere information object 25 as shown in (a) through (c) of FIG. 5. In this way, responding to movement of the viewpoint approaching each information object gradually, information is read from the network sequentially so that information necessary for screen display is constructed at any time.

The above explanation is for the example of change in display when user conducts operation approaching (zooming in) a specific information object using a pointing device (the input device 2) such as a mouse. The program of this embodiment further includes the steps in which when the user designates a destination as being explained later, the control portion 14 performs automatically the above-mentioned change of the display screen.

As an example, the user designates the URL of the destination information object. When the URL is designated, the control portion 14 searches the information object that is identical to the designated URL in such a way as to trace the link from the current information object. Then, the control portion 14 moves the viewpoint automatically until the position where the information object is displayed on the screen. For example, when the URL indicating one of the information objects 31 linked from the sphere information object 25 is designated in the state of display screen shown in FIG. 2 (or in (a) of FIG. 4), the changes of the display screen shown in FIGS. 4 and 5 are performed automatically without zooming-in operation by the user with a mouse or other devices. As a result, the viewpoint moves automatically to the position shown in (c) of FIG. 5.

The search of the destination information object is performed by tracing the link relationship as shown in FIG. 3 to check match of the URLs from the start point that is an information object displayed in the center of the display screen when the automatic movement is instructed. For example, in the display screen shown in FIG. 2, the large plate information object 22 is a start point for performing the search. First, concerning the information objects 23-26 including the box and the sphere linked to the large plate information object 22, it is checked whether each of them matches the URL designated as the destination or not.

If the matching URL is not found, the similar check of the URL is performed for information objects linked from the information objects 23-26. In this example, the URL of the information object 31 linked from the sphere information object 25 is identical to the URL designated as the destination, so this is regarded as the information object of the destination in the automatic movement.

In the above-mentioned search process, if the sphere information object 25 is not read from the network 6 yet, the URL of the information object that is linked from the sphere information object 25 cannot be known. In this case, since the information object having the URL of the destination cannot be found, the search ends in failure. Accordingly, the automatic movement of the viewpoint to the destination also ends in failure. Therefore, in the virtual three-dimensional information browsing method of this embodiment, not only the URL of the information object of the final destination but also one or more URLs on the path to the URL are designated as a destination of the automatic movement so that the above-mentioned failure can be avoided.

For example, in order to perform the automatic movement of the viewpoint shown in FIGS. 4 and 5, the URL of the information object 31 to be the destination as well as the URL of the sphere information object 25 on the movement path is designated before performing the automatic movement. First, information object matching the URL designated as the information object on the path is searched, and then the sphere information object 25 linked from the large plate information object 22 is found. Then, the destination is searched by checking the links from the sphere information object 25. If the information about the sphere information object 25 is not read from the network 6, a forced reading process is performed before the search so that the link information is prepared. When the preparation of the link information is completed, the search from the sphere information object 25 as a start point is performed so as to find the information object matching the destination URL, and the search will succeed.

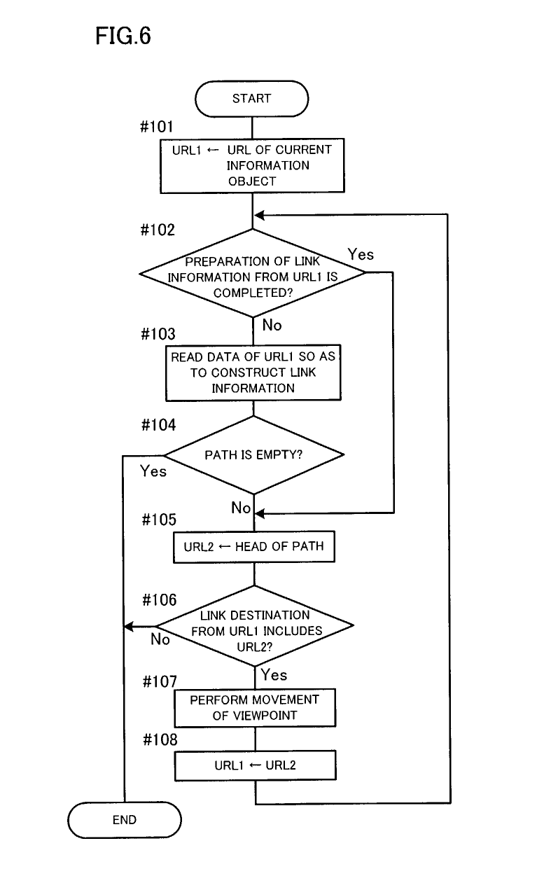

FIG. 6 is a flowchart of a first example showing a general process of the URL search explained above. In Step #101, the URL of the information object that is a current object of browse is assigned to URL1. In Step #102, it is checked whether preparation of the link information from the URL1 is completed or not. If the preparation is completed, the process jumps to Step #105.

If the preparation of the link information from the URL1 is not completed, the data of the URL1 are read from the network 6 in Step #103 so that the link information is constructed. In the following Step #104, it is checked whether the path is empty or not. If the path is empty, the process is finished since it means reaching the destination. If the path is not empty, the process goes to Step #105.

In Step #105, the head of the path is assigned to URL2. In Step #106, it is checked whether the link destination from the URL1 includes the URL2 or not. If it includes URL2, the movement of the viewpoint to the URL2 is performed in Step #107, and then the URL2 is reassigned as a new URL1 in Step #108. After that, the process is repeated from Step #102. If the URL2 is not included, it means that the search ends in failure, and the process is finished.

In this example of process, the search of the link destination information object and the movement of the viewpoint to the found information object are repeated alternately. Namely, every time when one information object is found, the movement of the viewpoint to the information object is performed (Step #107). Therefore, if the search ends in failure on the way to the destination, the viewpoint is moved to the information object just before the failure.

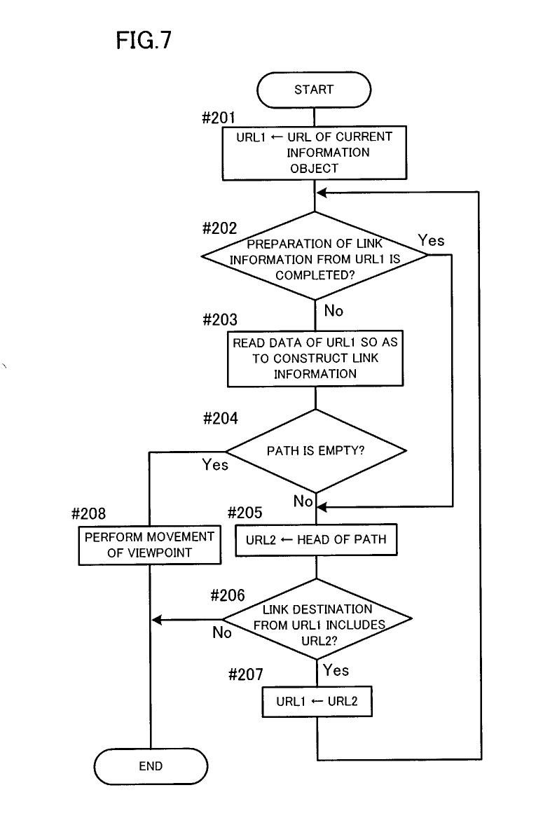

FIG. 7 is a flowchart of a second example showing a general process of the URL search. In this example, in contrast to the example shown in FIG. 6, the URL search to the destination is performed first (Steps #201-#207), and then the movement of the viewpoint is performed in the mass (Step #208). Also in this case, the change of the display screen is similar to the example shown in FIG. 6. Namely, the display screen changes so that the viewpoint moves sequentially tracing the path (the link).

Furthermore, in this example, in contrast to the example shown in FIG. 6, if the search ends in failure on the way to the destination, the movement of the viewpoint (i.e., the change of the display screen) is not performed (No in Step #206). However, it is possible to modify the flowchart shown in FIG. 7 so that the viewpoint is moved to the information object just before the failure in the case of “No” in Step #206.

As an alternative example of the process, though a flowchart is not shown, it is possible to constitute the process so that the URL search and the movement of the viewpoint are performed in different threads (or different tasks) independently. In this case, similarly to the example shown in FIG. 6, the viewpoint is moved to the information object just before the failure when the search ends in failure on the way to the destination.

The user's designation of the destination is performed by using a destination list that is displayed in the different manner from the display of the information object. Plural icons or character strings, which are related to the plural information objects respectively, are registered in the destination list in advance. The destination list is displayed on the screen. The user selects a desired icon or character string as a destination in the destination list using the input device 2 such as a mouse. The information registered in the destination list includes URLs indicating the information object to be the destination. Furthermore, it can include one or more URLs of the information objects on the path tracing the link to the destination URL as additional information.

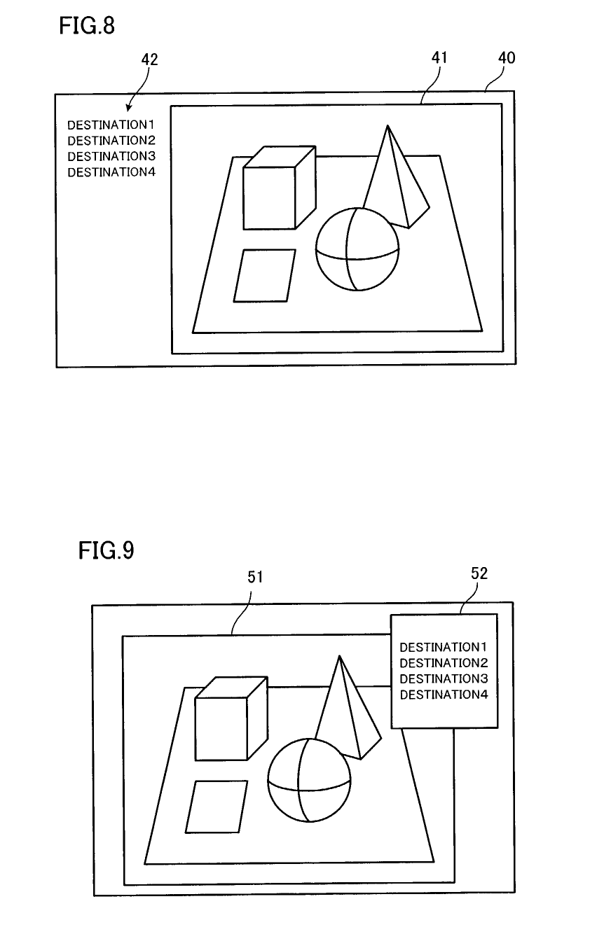

There are some forms of displaying the destination list as shown in FIGS. 8-10. FIG. 8 shows an example in which a destination list 42 is displayed in a margin set outside an information object display portion 41 of the virtual three-dimensional space within one window 40. For example, the information object display portion 41 is described in JAVA (a registered trademark) script, while the destination list 42 is described in HTML. In the display form shown in FIG. 9, a window 52 for displaying the destination list is provided independently of a window 51 for displaying the information objects of the virtual three-dimensional space.

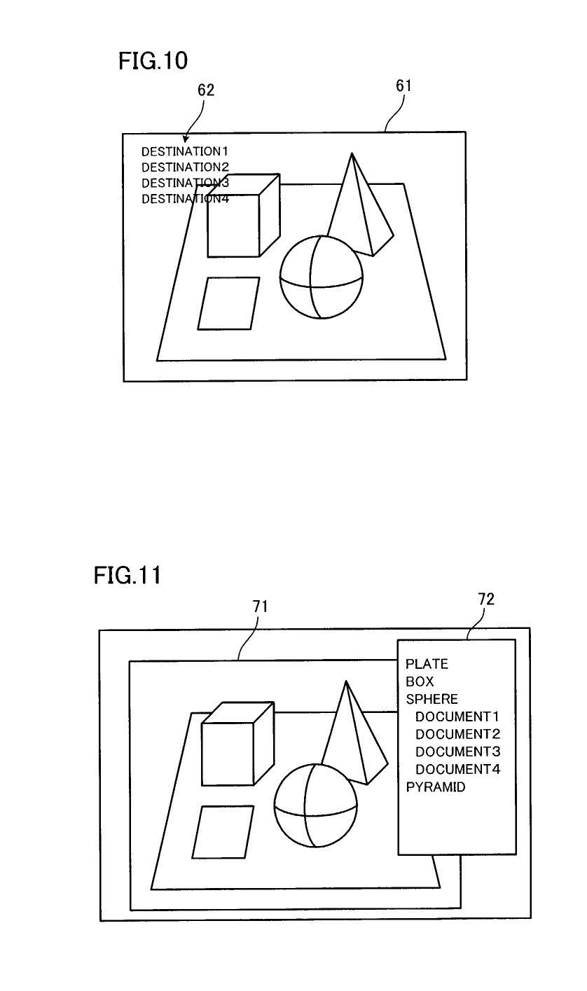

In the display form shown in FIG. 10, a destination list 62 is displayed so as to overlay on the information object in a window 61 for displaying the information object of the virtual three-dimensional space. In this case, it is possible that the destination list 62 is a translucent display and is changed to a solid display when being pointed by a mouse, for example.

FIG. 11 shows an example in which the destination list is displayed in a hierarchy manner indicating the link structure among the information objects. In this example, a window 72 for displaying the destination list is provided independently of a window 71 for displaying the information objects of the virtual three-dimensional space. Since the destination list is displayed in a hierarchy manner (or in a tree structure), the user can grab the relationship among the information objects more clearly so as to select a destination.

In FIG. 11, the user selects a document 1 after knowing that the information object of the document 1 is linked from the sphere information object from the display of the destination list, for example. As a result, as shown in FIGS. 4 and 5, the display screen alters automatically so that the viewpoint moves to the information object 31 of the document 1 via the sphere information object 25.

Thus, since each destination is related to a URL train indicating a path in the destination list, a specific object in the complicated hierarchy structure can be browsed freely only by selecting an anchor (a final destination) in the destination list. Though FIG. 11 shows an example in which only one information object exists on the path from the current information object to the destination object for simple explanation, many information objects can exist on the path in reality. In addition, there are many cases where the link relationship is complicated. In such cases, the virtual three-dimensional information browsing method of the present invention can work effectively.

According to the virtual three-dimensional information browsing method of the present invention, the movement of the viewpoint to an information object is performed automatically while the relative positions of the information objects located in the virtual three-dimensional space are maintained. Therefore, the user can browse various types of information easily with grabbing the information relationship.

While the presently preferred embodiments of the present invention have been shown and described, it will be understood that the present invention is not limited thereto, and that various changes and modifications may be made by those skilled in the art without departing from the scope of the invention as set forth in the appended claims.

What is claimed is:

1. A method for browsing virtual three-dimensional information, comprising the steps of:
locating a plurality of information objects that are related to each other by a link structure in a virtual three-dimensional space;
displaying some of the information objects on a display screen of a computer;
changing the display including the information objects in accordance with a field from a viewpoint that moves responding to user's operation; and
displaying a destination list on the display screen, the destination list including a plurality of icons or character strings related respectively to the information objects located on the virtual three-dimensional space, wherein when an icon or a character string included in the destination list is selected as a destination by an input device, a control portion searches a destination information object that is related to the selected icon or character string in accordance with the link structure and changes the display screen so as to alter tracing a link to the state of view where the destination information object is displayed.

2. The method according to claim 1, wherein an identifier of the destination information object is related to identifiers of plural information objects located on a path to the destination information object in accordance with the link structure for each of the plural icons or character strings.

3. The method according to claim 2, wherein if link information of the information object on the path is not read in when performing the search process, the control portion reads the link information newly before continuing the search of the destination.

4. The method according to claim 1, wherein the virtual three-dimensional space is displayed in a display window and the destination list is displayed in another display window.

5. The method according to claim 1, wherein the virtual three-dimensional space is overlaid with the destination list in a display window.

6. The method according to claim 1, wherein at least some of the plural icons or character strings included in the destination list are displayed in a hierarchical order in accordance with the link structure.

7. The method according to claim 1, further comprising the step of stopping the process of changing the display screen if at least one of the plural information objects located on the path to the information object related to the icon or the character string that was selected as the destination is not found by the search process.

8. The method according to claim 1, further comprising the step of setting a new destination to perform the process of changing the display screen if at least one of the plural information objects located on the path to the information object related to the icon or the character string that was selected as the destination is not found by the search process, the new destination being the information object that was found immediately before the search process.

9. A computer program that is installed in a computer for performing a method for browsing virtual three-dimensional information, the program making the computer perform the process comprising the steps of:
locating a plurality of information objects that are related to each other by a link structure in a virtual three-dimensional space;
displaying some of the information objects on a display screen of a computer;
changing the display including the information objects in accordance with a field from a viewpoint that alters responding to user's operation;
displaying a destination list on the display screen, the destination list including a plurality of icons or character strings related respectively to the information objects located on the virtual three-dimensional space;
searching a destination information object that is related to the selected icon or character string in accordance with the link structure when an icon or a character string included in the destination list is selected as a destination by an input device; and
changing the display screen so as to alter tracing a link to the state of view where the destination information object is displayed.

10. A storage medium storing a computer program that is installed in a computer for performing a method for browsing virtual three-dimensional information, the program making the computer perform the process comprising the steps of:
locating a plurality of information objects that are related to each other by a link structure in a virtual three-dimensional space;
displaying some of the information objects on a display screen of a computer;
changing the display including the information objects in accordance with a field from a viewpoint that alters responding to user's operation;
displaying a destination list on the display screen, the destination list including a plurality of icons or character strings related respectively to the information objects located on the virtual three-dimensional space;
searching a destination information object that is related to the selected icon or character string in accordance with the link structure when an icon or a character string included in the destination list is selected as a destination by an input device; and
changing the display screen so as to alter tracing a link to the state of view where the destination information object is displayed.
